(19) United States
(12) Patent Application Publication
(10) Pub. No.: US 2019/0001521 A1
(43) Pub. Date: Jan. 3, 2019

(54) WOOD SPLITTING DEVICE AND WOOD SPLITTING METHOD

(71) Applicant: Scheppach Fabrikation von Holzbearbeitungsmaschinen GmbH, Ichenhausen (DE)

(72) Inventor: Markus Bindhammer, Friedberg (DE)

(21) Appl. No.: 16/018,963

(22) Filed: Jun. 26, 2018

(30) Foreign Application Priority Data
Jun. 29, 2017 (EP) 17 020 277.4

(51) Int. Cl. B27L 7/06

(52) U.S. Cl. CPC B27L 7/06

(57) ABSTRACT

A wood splitting device includes a base formed as a base plate with a horizontally upwardly facing wood parking surface and a wood fixing arrangement fixed to the base for fixing a piece of wood disposed on the wood parking surface. The wood splitting includes a holder for holding a compressed-air-driven striking mechanism formed as a hand-held pneumatic hammer above the fixed piece. The pneumatic hammer has an upper-side handle, an actuator arrangement, and a tool carrier shaft, at the lower end of which a tool holder for receiving a splitting attachment is arranged. The holder is formed so that the pneumatic hammer is releasably attachable thereto. A wood splitting method includes disposing of a piece of wood to be split on a wood parking surface, fixing the disposed piece of wood, moving a striking mechanism into a working position, and operating and holding down the striking mechanism.

### CROSS REFERENCE TO RELATED APPLICATIONS

This application claims priority from European patent application EP 17 020 277.4, filed Jun. 29, 2017, the entire content of which is incorporated herein by reference.

### TECHNICAL FIELD

The invention relates to a wood splitting device and to a wood splitting method.

### BACKGROUND

Wood splitters are used to split tree trunk sections into logs, thus replacing the traditional method with splitting wedges driven by a hammer or ax.

Commercially available wood splitters are available in a vertical or horizontal configuration, wherein a tree trunk section can be set or inserted into a receptacle, and then a splitting wedge mounted on a hydraulic arm is driven endwise into the tree trunk section to split the tree trunk section. The hydraulic power is provided via an electric or gasoline engine. Such wood splitters provide good results, but are not only unwieldy, but too expensive for most end users, such as stove owners.

Such wood splitters are shown, for example, by German utility model DE 20 2012 005 222 U1, and French patent applications FR 2 845 027 A1 and FR 2 851 494 A1.

More mobile, simpler and more cost-effective is the wood splitting kit shown in the international patent application WO 2015/002606 A1 for wood splitting with a manually operated piling tool. In contrast, pneumatic hammers with splitting attachment promise significantly improved comfort, because the splitting force no longer has to be manually applied by the user.

Thus, in German Utility Model DE 20 2004 016 785 U1 a splitting attachment for a mechanically driven hammer, in particular a pneumatic hammer, is revealed. By way of example, U.S. Pat. No. 4,669,552 is mentioned, which shows the splitting of a tree trunk section by a pneumatic hammer with such a splitting attachment.

The splitting of wood in the manner shown there with a pneumatic hammer, however, involves considerable risk of injury. In addition, such pneumatic hammers for end users who want to split wood continue to be expensive to purchase.

### SUMMARY

On this basis, it is an object of the present invention to provide a wood splitting device and a wood splitting method with which the splitting of wood is also economically and safely possible for consumers.

This object is achieved by the wood splitting device and the wood splitting method as disclosed herein.

According to an aspect of the invention a wood splitting device is provided for the compressed-air-driven splitting of pieces of wood, e.g., in the form of tree trunk disks or sections, into logs. The wood splitting device includes a base, formed as a base plate for example, having a horizontally upwardly facing wood parking surface. It further includes a wood fixing arrangement attached to the base for fixing a wood piece on the wood parking surface and a holder for holding a compressed-air-driven striking mechanism above the fixed piece of wood. The holder is designed to hold a striking mechanism, which is formed as a hand-held pneumatic hammer and has an upper-side handle and actuator assembly and a tool carrier shaft, at the lower end of which a tool holder for receiving a splitting attachment is arranged. The holder is further constructed so that the striking mechanism formed as such a pneumatic hammer is releasably attachable thereto.

The wood splitting method according to an aspect of the invention for compressed-air-driven splitting of pieces of wood into logs includes the steps of disposing a piece of wood to be split on a horizontally upwardly facing wood parking surface, fixing the disposed piece of wood there, moving a striking mechanism height-adjustably attached to a guide rail assembly above the fixed piece of wood from a spaced-apart position of the piece of wood into a working position, in which the splitting attachment of the striking mechanism is seated on the fixed piece of wood, as well as actuating and holding down the striking mechanism. In this case, the wood splitting method according to an aspect of the invention is carried out with the wood splitting device according to another aspect of the invention.

The wood splitting device according to an aspect of the invention thus provides a frame for attaching a striking mechanism and for fixing the wood piece to be split, which makes it possible to carry out the splitting in a guided movement supported on the frame, so that the risk of injury as compared with the use of pneumatic hammers without such a frame is substantially reduced. Thus, an affordable wood splitting device can be provided for the consumer, in particular if the compressed-air-operated striking mechanism is advantageously already a part of the wood splitting device, while still providing the necessary security when operating the device.

Due to the fact that the holder is designed for releasably attaching the striking mechanism, in particular releasably in a tool-free manner, universally useable striking mechanisms can also be attached to the wood splitting device, which may have multiple benefits for the end user, who may then reuse them for other purposes if the respective striking mechanism is not attached to the wood splitting device, which mechanism is then used for different purposes in the home and garden.

Therefore, hand-operated pneumatic hammers, which are generally T-shaped, are available on the market, which have at their lower end a tool holder on which different tool attachments fit, such as a shovel blade attachment in order to use the pneumatic hammer as compressed-air spade. Such pneumatic hammers can be provided with a wood splitting attachment for splitting wood and used with the wood splitting device.

The wood splitting device is configured to receive such a pneumatic hammer. The wood splitting device can also be provided together with such a pneumatic hammer which is also usable for other purposes. The operation during wood splitting is then carried out at the top grip and operating portion of the pneumatic hammer, as well as other possible uses, such as a compressed-air spade.

The holder for the striking mechanism or the striking mechanism configured as a pneumatic hammer of the type described above can have a carrier for the striking mechanism or the pneumatic hammer that is fastened to the base, i.e., for example, screwed or welded thereon. The carrier may in turn have a guide rail arrangement on which the striking mechanism is displaceably accommodated with a degree of freedom in the striking direction, i.e., preferably in the vertical direction. Advantageously, the guide rail arrangement is configured so that the striking mechanism or the pneumatic hammer is not only slidably mounted in the vertical direction, but also accommodated in a manner fixable in height.

When setting up the piece of wood to be split on the base, the striking tool or the pneumatic hammer can then be moved upwards along the guide rail arrangement in order to provide the space required for setting up the piece of wood. If the piece of wood is standing, the striking mechanism or the pneumatic hammer is lowered again, so that the splitting attachment stands up on the piece of wood. Advantageously, the striking mechanism or the pneumatic hammer can then also be fixed in this altitude. Further advantageously, a return spring is provided, which pretensions the striking mechanism upwards against the striking direction, so that after releasing the fixation the striking mechanism is raised automatically to set up the next piece of wood to be split. It would also be conceivable to provide a damper to dampen the impacts acting on the user on the handle of the pneumatic hammer.

It would also be conceivable to provide the holder for the striking mechanism in the manner of a drill stand with the above-described return spring to upwardly move the striking mechanism after wood splitting back to the starting position for setting up a new piece of wood, and to also provide a lever mechanism, e.g., a rotary lever, via which the striking mechanism can be lowered or raised in a simple manner.

The guide rail arrangement may be formed as a guide rod which protrudes preferably vertically upwardly from the base against the striking direction, wherein the holder has at least one support yoke which encloses the guide rod on several sides, preferably completely, and on which the striking mechanism is attached or—in the case of a removable, multi-use striking mechanism or pneumatic hammer—is attachable.

The holder may further includes a pipe clamp arrangement which can be brought from an open receiving position for attaching the pneumatic hammer to the holder into an operation position, in which it surrounds or encloses and preferably clamps or grips the tool carrier shaft of the pneumatic hammer. The pipe clamp arrangement can be attached in this case to the support yoke. Overall, this results in a secure mounting of the pneumatic hammer on the frame with the erected piece of wood, so that slipping when splitting wood is avoided.

In order to ensure a secure hold of the piece of wood to be split or to prevent the logs from falling apart in all directions during or after splitting and thus possibly surprising the user which causes him or her to slip with the pneumatic hammer, the wood fixing arrangement may include two retaining arms, in particular provided with retaining claws, which retaining arms are pivotably hinged to the base or the holder horizontally from a wood receiving position into a wood fixing position and back. In order to thus ensure that the two retaining arms securely clamp the wood piece to be split securely between them in the wood fixing position, advantageously a tension spring which pretensions the two retaining arms in the wood fixing position with respect to each other can be provided. In order to facilitate the erection of the piece of wood and the subsequent clamping thereof between the two retaining arms, it is furthermore advantageous if the two retaining arms can be locked in the wood receiving position.

### BRIEF DESCRIPTION OF THE DRAWINGS

The invention will now be described with reference to the drawings wherein:

FIG. 1 shows a perspective view of a multi-function pneumatic hammer for use with a wood splitting device according to an exemplary embodiment of the invention;

FIG. 2 shows a perspective view of the wood splitting device from the front; and

FIG. 3 shows a perspective view of the wood splitting device from the back.

### DESCRIPTION OF EXEMPLARY EMBODIMENTS

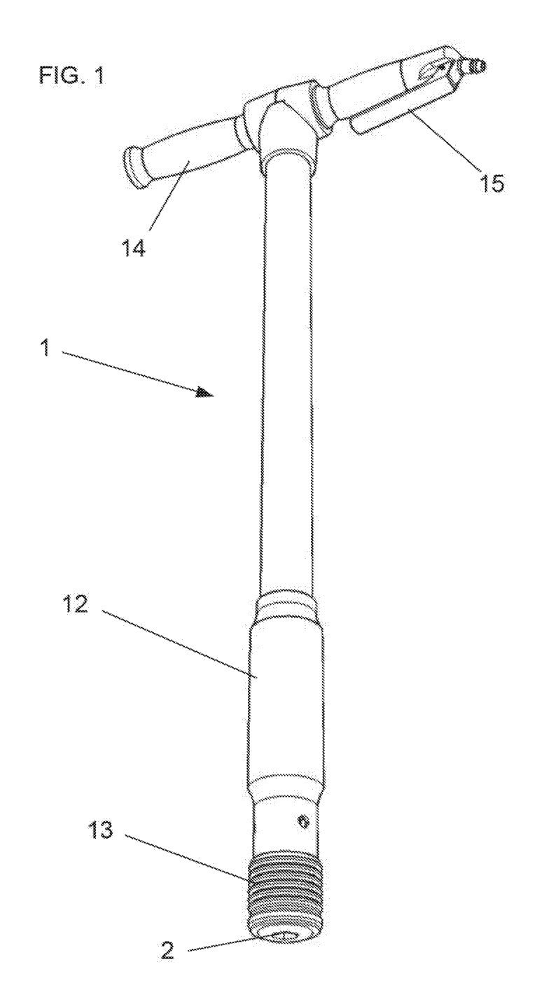

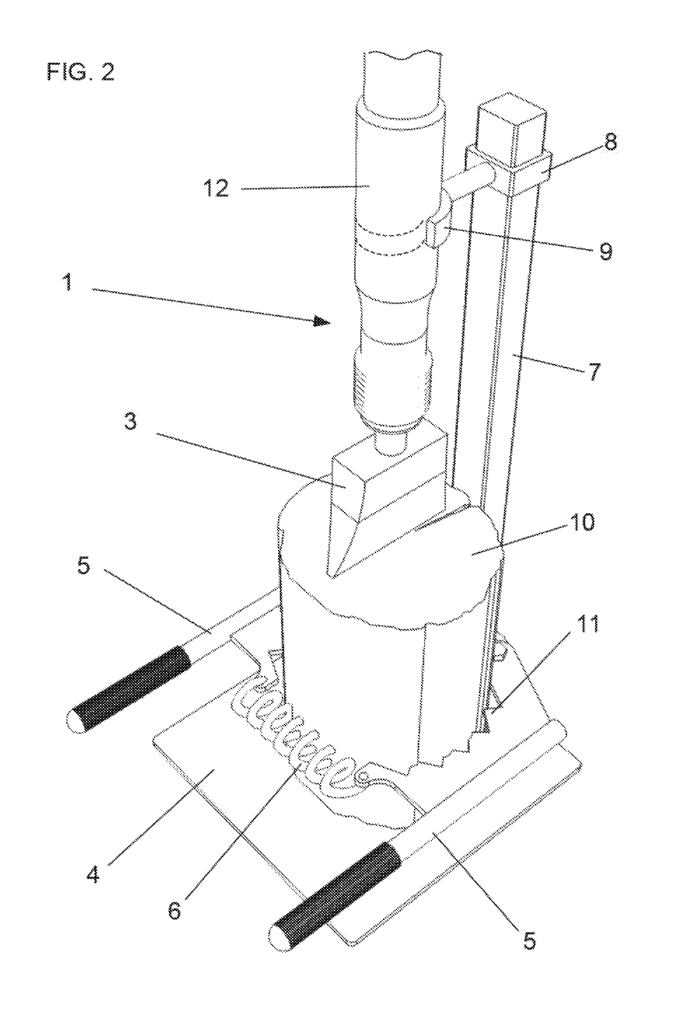

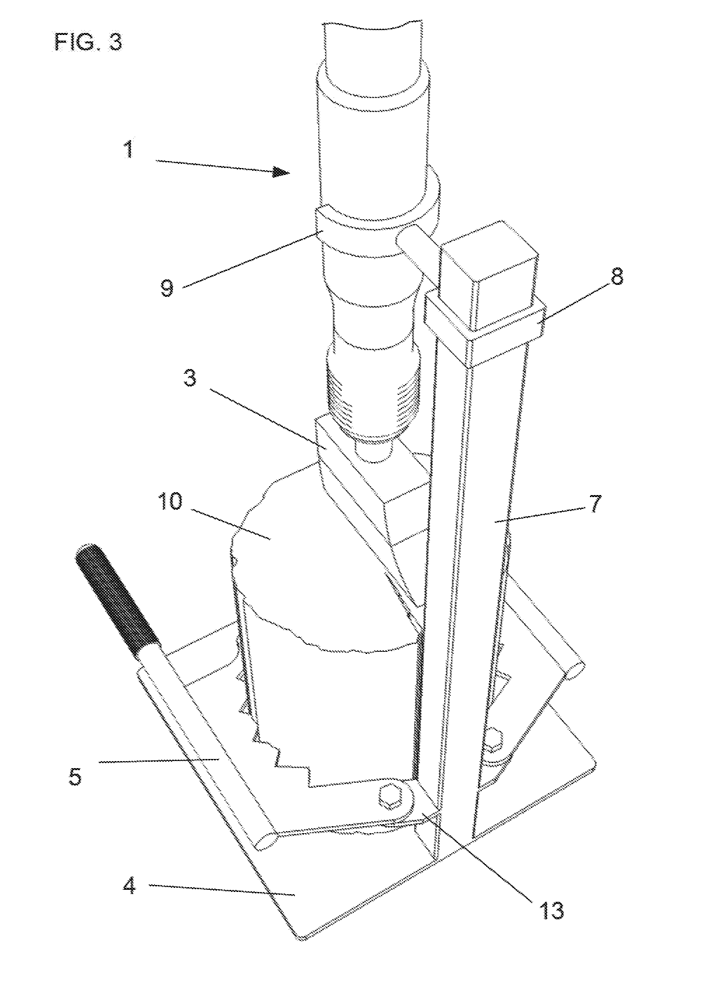

Reference is made first to FIG. 1, which shows a generally T-shaped pneumatic hammer designated by reference numeral 1, which has at its lower end a tool receptacle 2 configured as a hexagon-shaped receptacle with additional thread 13, to which different tools can be attached, and at its upper end a handle arrangement 14 which can be gripped with both hands and which is designed as a crossbar. Via a pull lever 15 configured as actuating arrangement, compressed-air supply on the handle side can be operated, via which the compressed air is conducted through internal lines to a striking mechanism unit arranged in the tool holder shaft leading from the handle arrangement 14 downwardly to the tool holder 2. The tool carrier shaft in this case has in its lower third a guide section 12 with an approximately circular outer cross-section, on which the pneumatic hammer 1 can be accommodated for wood splitting in a guided manner in a holder, as shown in the following FIGS. 2 and 3. Therein, the internal striking mechanism unit can be accommodated in the region of the slightly projecting guide section 12 in order to act from there on the lowest section of the tool shaft and thereby move it.

FIGS. 2 and 3 show the pneumatic hammer 1 in use on a wood splitting device. The wood splitting device in this case has a base formed as a base plate 4, to which a vertically upwardly projecting guide rod 7 in square shape is welded. At the bottom of the guide rod 7, two horizontally projecting fastening tabs 13 (FIG. 3) are welded, to each of which a retaining arm 5 is hinged. The two retaining arms 5 are each provided with retaining claws 11 and together with a tension spring 6 form a wood fixing arrangement for fixing a piece of wood 10 parked on the wood parking surface of the base plate 4, said piece of wood being provided here in the form of a tree trunk disk.

A support yoke 8 surrounding the guide rod 7 on all sides is accommodated on the guide rod 7, to which a pipe clamp arrangement indicated with reference numeral 9 is attached via a bar, which is not designated. The pipe clamp arrangement 9 surrounds the tool carrier shaft of the pneumatic hammer 1 in its guide section 12, as indicated by dashed lines in FIG. 2.

The guide rod 7, the support yoke 8 and the pipe clamp arrangement 9 thus together form a holder for holding the pneumatic hammer 1 above the fixed piece of wood 10. It would be conceivable to form the holder separately from the base, i.e., the base plate 4 with the wood fixing arrangement attached thereto, e.g., for attachment to a wall. In the exemplary embodiment shown, however, the guide rod 7 forms a carrier fixed to the bottom plate 4.

Deviations from the illustrated embodiment are possible without contradicting the spirit of the invention.

Thus, it would be conceivable, for example, to form the pipe clamp arrangement 9 by a plurality of pipe clamps encompassing the guide section 12 at different heights, whereby a more secure guidance of the pneumatic hammers 1 in the vertical direction would be ensured. It would also be conceivable to provide the pipe clamp arrangement 9 with wider pipe clamps. Furthermore, locking screws could be provided for fixing the support yoke 8 at a certain height on the guide rod and/or corresponding locking screws for fixing the pneumatic hammer 1 to the pipe clamp arrangement. 9

It is understood that the foregoing description is that of the exemplary embodiments of the invention and that various changes and modifications may be made thereto without departing from the spirit and scope of the invention as defined in the appended claims.

What is claimed is:

1. A wood splitting device for compressed-air-driven splitting of pieces of wood in the form of tree trunk disks into logs, the wood splitting device comprising:
a base formed as a base plate with a horizontally upwardly facing wood parking surface;
a wood fixing arrangement fixed to the base for fixing a piece of wood disposed on the wood parking surface;
wherein:
the wood splitting device for compressed air-driven splitting of the pieces of wood has a holder for holding a compressed-air-driven striking mechanism formed as a hand-held pneumatic hammer above the fixed piece of wood,
the pneumatic hammer has an upper-side handle and actuator arrangement and a tool carrier shaft, at the lower end of which a tool holder for receiving a splitting attachment is arranged, and
the holder is formed so that the pneumatic hammer is releasably attachable thereto.

2. The wood splitting device according to claim 1, wherein the holder is designed so that the pneumatic hammer is releasably attachable without tools.

3. The wood splitting device according to claim 1, further comprising a splitting attachment to be operated by the striking mechanism for splitting the fixed piece of wood,
wherein the splitting attachment is configured to fasten to the striking mechanism and/or the holder, so that during wood splitting it has only a translational degree of freedom in the direction of striking, preferably in the vertical direction.

4. The wood splitting device according to claim 1, further comprising the compressed-air-driven striking mechanism, wherein the striking mechanism is configured as the pneumatic hammer, which, taken as a whole, is T-shaped.

5. The wood splitting device according to claim 4, wherein the pneumatic hammer, in addition to the splitting attachment, has at least one further tool attachment that fits its tool holder, in particular a shovel blade attachment.

6. The wood splitting device according to claim 1, wherein the holder has a carrier for the striking mechanism which is fastened to the base, in particular welded thereon.

7. The wood splitting device according to claim 6, wherein the carrier has a guide rail arrangement on which the striking mechanism is accommodated with freedom in the striking direction, preferably displaceable in the vertical direction and preferably in a fixable manner.

8. The wood splitting device according to claim 7, wherein a return spring is provided, which pretensions the hammer mechanism upwards against the striking direction.

9. The wood splitting device according to claim 7, wherein the guide rail arrangement is formed as a guide rod which preferably protrudes upwardly from the base against the striking direction and the holder comprises a carrier yoke which encloses the guide rod on several sides, preferably completely, to which the striking mechanism is attached or is at least attachable.

10. The wood splitting device according to claim 4, wherein the holder has a pipe clamp arrangement which can be brought from an open receiving position for attaching the pneumatic hammer on the holder into an operation position, in which it surrounds the tool carrier shaft preferably on a circular pipe section, preferably gripping said shaft.

11. The wood splitting device according to claim 10, wherein the pipe clamp arrangement is attached to the guide rod, preferably fastened to the carrier yoke.

12. The wood splitting device according to claim 1, wherein the wood fixing arrangement comprises two retaining arms especially provided with retaining claws, which are pivotably hinged on the base or the holder horizontally from a wood receiving position into a wood fixing position and back.

13. The wood splitting device according to claim 12, wherein the wood fixing arrangement comprises a tension spring pretensioning the two retaining arms in the wood fixing position.

14. The wood splitting device according to claim 12, wherein the two retaining arms can be locked in the wood receiving position.

15. A wood splitting method for compressed-air-driven splitting of pieces of wood in the form of tree trunk disks into logs, the method comprising:
disposing a piece of wood to be split on a horizontally upwardly facing wood parking surface;
fixing the disposed piece of wood there;
moving a striking mechanism attached in a height-adjustable manner to a guide rail arrangement above the fixed piece of wood from a position spaced from the piece of wood into a working position in which a striking attachment of the striking mechanism is seated on the fixed piece of wood, and
operating and holding down the striking mechanism,
wherein the wood splitting method is performed with a wood splitting device according to claim 1.
